(19) United States
(12) Patent Application Publication
(10) Pub. No.: US 2020/0099960 A1
(43) Pub. Date: Mar. 26, 2020

(54) Video Stream Based Live Stream Interaction Method And Corresponding Device

(71) Applicant: Guangzhou Huya Information Technology Co., Ltd., Guangzhou, Guangdong (CN)

(72) Inventors: Chuan Yu, Guangzhou, Guangdong (CN); Meng Yu, Guangzhou, Guangdong (CN); Xiaodong Wu, Guangzhou, Guangdong (CN); Hao Wu, Guangzhou, Guangdong (CN); Liyong Cao, Guangzhou, Guangdong (CN)

(73) Assignee: Guangzhou Huya Information Technology Co., Ltd., Guangzhou, Guangdong (CN)

(21) Appl. No.: 16/467,383

(22) PCT Filed: Oct. 23, 2017
(86) PCT No.: PCT/CN2017/107320

§ 371 Date: Jun. 6, 2019

(30) Foreign Application Priority Data
Dec. 19, 2016 (CN) 201611177841.5

(51) Int. Cl. H04N 21/2187; H04N 21/44; H04N 21/4788; H04N 21/414; A63F 13/86

(52) U.S. Cl. CPC H04N 21/2187; H04N 21/44008; A63F 13/86; H04N 21/41407; H04N 21/4788

(57) ABSTRACT

The present disclosure provides a video stream based live stream interaction method and apparatus, the method includes the following steps: performing image recognition on a received video stream of a streamer, and acquiring feature change information of a featured object in the video stream, thereby generating a corresponding action event; determining a preset response instruction for the action event according to the action event itself; and executing the response instruction to send feedback information to at least one user in a live streaming room in response to the action event. The method and device can automatically complete the interaction with the live broadcast party using image recognition technology and send the interactive notification information to the live broadcast user, thereby improving the interaction between the user and live broadcast party, and enhancing the flexibility of the scheme, enhancing user experience.

### CROSS-REFERENCE TO RELATED APPLICATIONS

The present application is a national phase entry under 35 U.S.C § 371 of International Application No. PCT/CN2017/107320 filed Oct. 23, 2017, which claims priority from Chinese Application No. 201611177841.5 filed Dec. 19, 2016, all of which are hereby incorporated herein by reference.

### FIELD OF THE DISCLOSURE

The present disclosure relates to Internet technologies, and in particular, to a video stream based live stream interaction method and corresponding device.

### BACKGROUND OF THE DISCLOSURE

Nowadays, as network technology matures, online interactive live streaming is gradually being understood by people. Online interactive live streaming usually refers to webcasts with interactive content, which go through early text interaction (chat communication), voice interaction and then to video interaction. Since the plain meaning of interaction is mutual influence, it is hard to realize online interactive live streaming in traditional live broadcast and live TV. Because it is network-based, online live streaming inherits and enhances the characteristics of the Internet, and the biggest feature of webcasting is that the viewers/listeners can take more initiative; the interactive nature is unprecedented in the live broadcast history.

In prior art technical solution, the user realizes the interactive nature by watching the performance of the streamer and sending gifts based on the wonderful performance of the viewed streamer. For example, during the process of watching a gameplay streamed by a game streamer, in case a certain game character wins or is on a killing streak, the user sends a gift or likes to realize the interaction. The user needs to manually determine whether the streamer has completed the corresponding action or whether the character in game has completed a specific action, resulting in human operation, and lacking intelligence.

It can be seen that the prior art realizes the interaction between the user and the streamer of a streaming terminal with cumbersome operations, insufficient intelligence, less amusement, and reduced user viewing experience.

### SUMMARY OF THE DISCLOSURE

In view of the above problems, the present disclosure provides a video stream based live stream interaction method and corresponding device.

The present disclosure also provides a mobile terminal for performing a video stream based live stream interaction method of the present disclosure.

In a first embodiment, the present disclosure provides a video stream based live stream interaction method including the steps of performing image recognition on a received video stream of a streamer, and acquiring feature change information of a featured object in the video stream, thereby generating a corresponding action event; determining a preset response instruction for the action event according to the action event itself; and-executing the response instruction to send feedback information to at least one user in a live streaming room in response to the action event.

In a second embodiment, the present disclosure provides a video stream based live stream interaction device, including:

an identification module for performing image recognition on a received video stream of a streamer, and acquiring feature change information of a featured object in the video stream, thereby generating a corresponding action event;

a determination module for determining a preset response instruction for the action event according to the action event itself; and

a sending module for executing the response instruction to send feedback information to at least one user in a live streaming room in response to the action event.

In a third embodiment, the present disclosure provides a mobile terminal, including:

a touch-sensitive display for displaying a user interface for human-computer interaction;

one or more processors;

memory; and

one or more applications, wherein the one or more applications are stored in the memory and configured to be executed by the one or more processors; the one or more programs are configured to drive the one or more processors to construct modules for performing the methods described above.

Compared with the prior art, the technical solution of the present disclosure has at least the following advantages.

The present disclosure provides a video stream based live stream interaction method and corresponding device. Image recognition technology is used to identify the action information of a person character or an item character in a current video stream to automatically determine the state of a play event in the current video stream, so that the terminal responds accordingly based on the identified dynamic change information, together with the interaction with the user at the viewing end, without need for people to confirm each detail.

Specifically, the present disclosure performs image recognition on dynamic change information of a person character or an item character or a moving part in a current video stream, thereby generating a corresponding action event based on the dynamic change information. A response instruction corresponding thereto is determined according to the action event to execute the instruction to send feedback information to at least one user in the live stream room in response to the action event.

The disclosure can apply the image recognition technology to the live broadcast technology, automatically recognize the dynamic change of the character or the item in the current video stream image, acquire the progress of the current video stream play event through the image recognition technology, and automatically send the corresponding feedback information to realize automatic interaction of the live streaming, without confirmation of every detail by human, which brings enhanced user experience, simple operation and high flexibility.

### BRIEF DESCRIPTION OF THE DRAWINGS

In order to more clearly illustrate the technical solution in the embodiments of the present disclosure, the drawings used in the description of the embodiments will be briefly described below. It is obvious that the drawings in the following description are only some embodiments of the present disclosure. For those skilled in the art, other drawings can be obtained according to these drawings without any creative work.

FIG. 1 is a flow chart of a first embodiment of a video stream based live stream interaction method according to the present disclosure;

FIG. 2 is a flow chart of a second embodiment of a video stream based live stream interaction method according to the present disclosure;

FIG. 3 is a schematic structural diagram of a first embodiment of a video stream based live stream interaction device according to the present disclosure;

FIG. 4 is a schematic structural diagram of a second embodiment of a video stream based live stream interaction device according to the present disclosure; and

FIG. 5 is a structural block diagram of a part of a mobile terminal according to the present disclosure.

### DETAILED DESCRIPTION OF THE DISCLOSURE

In order to achieve the above objectives, technical solution and advantages of the present disclosure clearer, the embodiments of the present disclosure will be further described in detail below with reference to the accompanying drawings.

In the flow of the description of the disclosure and the claims and the above-described figures, a plurality of operations in a particular order are included, but it should be clearly understood that these operations may not follow the order in which they appear in this document. The serial number of the operation, such as S11, S12, etc., is only used to distinguish the different operations, and the serial number itself does not represent any execution order. Additionally, these processes may include more or fewer operations, and these operations may be performed sequentially or in parallel. It should be noted that the descriptions of “first” and “second” in this document are used to distinguish different messages, devices, modules, etc., and do not represent the order. It is also not limited that the “first” and “second” certainly are intended for a different type.

It should be understood by person of the ordinary skill in the art that unless otherwise specified, terms “a”, “one”, “the” and “said” in singular form may also be used in plural form. It should be further understood that the term “include” as used herein means presence of said feature, integer, step, operation, element and/or component, but not excluding presence of one or more additional other feature, integer, step, operation, element and/or component and/or their combination. The term “and/or” includes one or more related elements and all combination thereof.

It should be understood by a person of the ordinary skill in the art that unless otherwise specified, all the terminology (including technical and scientific terms) have their ordinary meaning as understood by person of the art.

It should also be understood that those terms defined in s general dictionary should be understood to have meanings that are consistent with the meaning in the context of the prior art, and should not be interpreted in an ideal or overly formal meaning unless specifically defined herein.

The image classification and display method of the present disclosure is mainly applicable to a terminal having a communication function such as a smart phone terminal or a smart tablet terminal, and is not limited to the type of its operating system, and may be an operating system such as Android, IOS, WP, and Symbian.

The technical solutions in the embodiments of the present disclosure are clearly and completely described in the following embodiments of the present disclosure with reference to the drawings, wherein the same or similar reference numerals indicate the same or similar elements or elements having the same or similar functions. It is apparent that the described embodiments are only a part of the embodiments of the disclosure, and not all of them. All other embodiments obtained by a person skilled in the art based on the embodiments of the present disclosure without creative efforts are within the scope of the present disclosure.

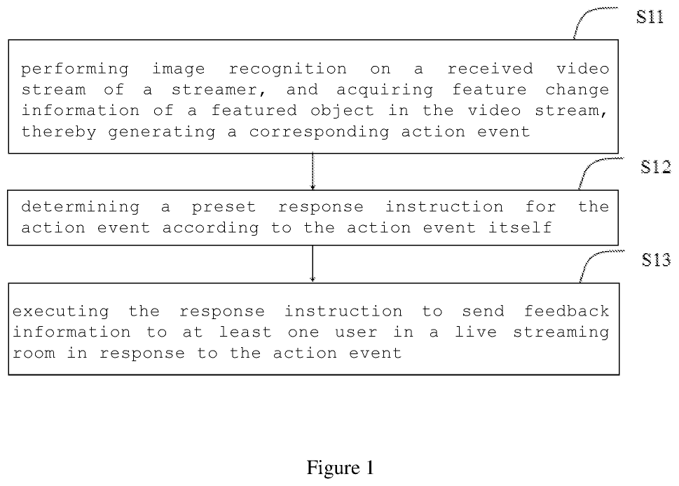

Referring to FIG. 1, the present disclosure provides a video stream based live stream interaction method. In a specific embodiment, the method includes a step S11 of performing image recognition on a received video stream of a streamer, and acquiring feature change information of a featured object in the video stream, thereby generating a corresponding action event.

In the embodiment of the present disclosure, to obtain the feature change information of the featured object in the video stream, thereby generating a corresponding action event, the method further includes identifying a featured object in each image frame of each received video stream; determining feature change information from features included in each of the image frames when a plurality of consecutive image frames include preset features of the featured object; and matching the determined feature change information with a preset action event parameter template, and when the feature change information matches one of the parameter templates, generating an action event corresponding to one of the parameter templates.

The featured object is a reference for extracting its dynamic change information to determine a state of a play event in the current video stream. The featured object may be any one of a person character, an item character, and a moving part in the video stream; for example, a streamer of a current live streaming room or the game character of a currently live video game event or players of currently live video game and the like.

When identifying the featured object in the video stream, the dynamic change process of the feature is specifically identified. When it is identified that a plurality of consecutive image frames include preset reference features of the featured object, change information of the feature between different image frames is further identified. The change information of the featured object is a change in position, shape, or both position and shape, of the person character, item character, or the moving part in a plurality of consecutive image frames of the video stream.

Specifically, when a plurality of consecutive image frames are played, in case that the position or shape of the specific feature of the featured object included therein has changed, then such change is determined as the feature change information among the features included in each of the image frame.

In a possible application scenario, for example, a current event streaming live is a game event, and when a killing action of a certain game character is recognized, the recognition process may specifically identify the shape of the sword or other devices held by the game character and changes in the position of the game character's arm or body to determine the completion of this killing action. When the action is finished, the completion of a killing action would be recorded as feature change information of the game character.

In the embodiment of the present disclosure, the corresponding action events generated by the determined feature change information are specifically implemented by matching the description parameter items of each other. The feature change information and the parameter template share the same parameter description items, and the same parameter description items are compared with each other to realize match between each other.

For example, in the application of the video game live broadcast, the parameter description item of the killing action may be: change in the arm coordinates of the killer, coordinate change of the center point of the body, and shape change of the sword. The feature change parameter description items of the corresponding featured object are: coordinate changes of features a and b of featured object A, and shape change of featured object B. In this embodiment, the featured object A is a killer, the feature a is its arm, the feature b is its body center point, and the featured object B is a sword. The parameter description items are: coordinate change of the arm of the killer, coordinate change of the center point of the body, and the shape change of the sword. When this dynamic change information of the featured object is identified, it is determined that it completes a kill action.

In one embodiment, the video stream based live stream interaction method further includes a step S12 of determining a preset response instruction for the action event according to the action event itself.

In the embodiment of the present disclosure, a mapping relationship between the action event and its response instruction is pre-stored by a terminal in order to determine a preset response instruction for the action event. When it is recognized that a certain action event occurs, a corresponding response instruction according to the mapping relationship is determined, so that the terminal executes the instruction to send feedback information to at least one user in the live stream room in response to the event.

The mapping relationship includes a corresponding relationship between an attribute of the action event and response instruction. In a possible design, the mapping relationship further includes a corresponding relationship between the number of times the action event is sent and response instruction. The corresponding relationship is used to represent that the response instruction is determined if and only if the action event reaches for a predetermined number of occurrence. In one possible design, the mapping relationship includes that different occurrences of a particular action event correspond to different response instructions.

For example, in the application scenario of the above video game live broadcast, when it is recognized that a game character M completes one kill, the preset response instruction is giving a thumb-up and the kill action is counted. When it is recognized that it completes two killing actions, the preset response instruction is to send a gift, and continue to count the killing actions, so that when the terminal responds to the killing action, feedback information including sending the gift, or thumb-up and the number of times the game character M completes the killing are displayed in a user interface.

In one embodiment, when receiving the configuration of the response instruction for the preset action event, the action event is stored in association with the corresponding response instruction to refresh the mapping relationship in real time to determine the response instruction according to the action event.

In one embodiment, the video stream based live stream interaction method further includes a step S13 of executing the response instruction to send feedback information to at least one user in a live streaming room in response to the action event.

In some embodiments, the response instruction can be in any of the following forms: a dispatch instruction for dispatching an electronic gift to a streamer, the instruction causing at least a notification information, which includes the information about dispatching the electronic gift to the streamer; a sending instruction for sending a preset text to a streamer, the instruction causing generation of a notification information including at least the text to be sent to the streamer; and a broadcast instruction for broadcasting a preset text to a live stream room, the instruction causing a plurality of users in the live stream room to receive a notification information including the text.

For example, in a live game, when the game character completes five consecutive killing actions, the terminal automatically recognizes the dynamic change information of the game character, and automatically sends an electronic gift such as displaying achievements or a virtual gift. Delivery notification information including dispatch of the electronic gift is sent to at least one user in the live stream room when the terminal executes the instruction. In one embodiment, the number of kill actions of the game character is also displayed on the user interface. When the user misses the killing scene of the game character due to temporary departure or other things, he can still make corresponding interactions through the notification information and the killing result displayed on the user interface, thus enhancing the interaction between users and the live broadcast party, and improving the user experience.

When the response instruction is executed, the preset text information may be information such as the number of occurrences of dynamic change information in the live video stream or the attributes and quantity of the virtual gifts that are sent out due to identification of certain dynamic change information. The text information is used to let the user know the dynamic change process and the feedback information that the terminal made in response to the dynamic change process. In this case, the user does not have to manually confirm the progress of the current live event, and the user can infer the event that has occurred from the notification information, so that the user can follow the progress of the live event in real time and user experience is improved.

When the response instruction is executed, the notification information feedback is used to be sent to all users in the live stream room, ensuring that all users can receive the notification information.

It should be noted that the type of the response instruction described in the embodiment of the present disclosure may also be other instructions, which are not limited to the above three types of instructions, and are not limited herein.

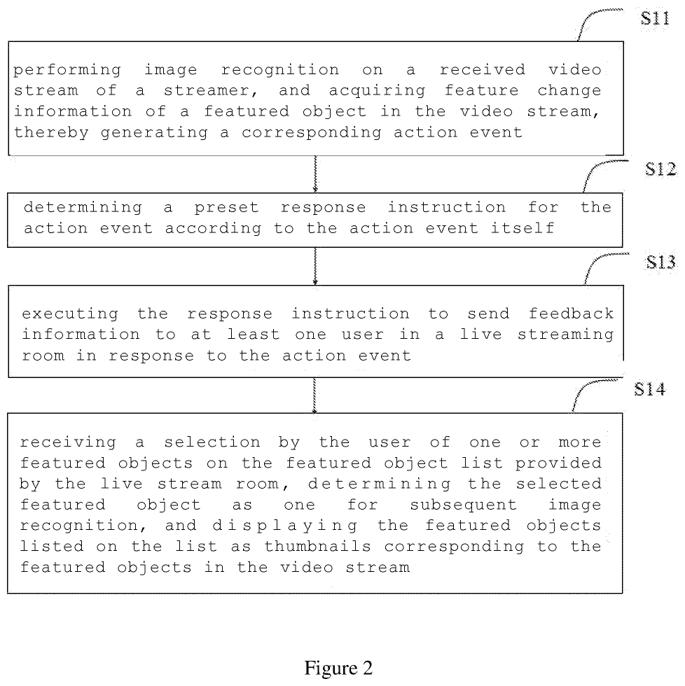

Referring to FIG. 2, in another embodiment of the present disclosure, a step S14 is further included for receiving a selection by the user of one or more featured objects on the featured object list provided by the live stream room. The selected featured object is determined as the featured object for subsequent image recognition, and the featured objects listed on the list are displayed as thumbnails corresponding to the featured objects in the video stream.

In the embodiment of the present disclosure, the video stream may include multiple featured objects. When multiple featured objects appear on the same screen at the same time, the user may select to pay special attention to the dynamic change information of a certain feature. For example, during the live broadcast of a game, the user only wants to pay attention to the performance of the contestants he cares about. At this time, the user can pay attention to one or more featured objects by selecting from the featured object lists.

Specifically, the terminal provides a user interaction interface for selecting featured objects, so that the user may selects one or more featured objects on the featured objects list, and the terminal determines that the selected featured objects as the featured object for subsequent image recognition. When the video stream is undergoing image-recognition, dynamic information change of the selected featured object is identified and recorded, so that the terminal executes a corresponding response instruction according to the recognition result, so as to feed back the corresponding notification information to the users in the live stream room.

The featured objects listed on the list are displayed as thumbnails corresponding to the featured objects in the video stream. The featured object list further includes a reference feature preset for the featured object to determine an initial state of the same featured object in the video stream image to determine the feature change information.

For example, when the user selects one or more featured objects as the ones to be identified, the terminal determines an initial state of a featured object to be identified according to the featured object list, and the initial state is a reference point for dynamic information change. Based on this, its subsequent dynamic change information is determined.

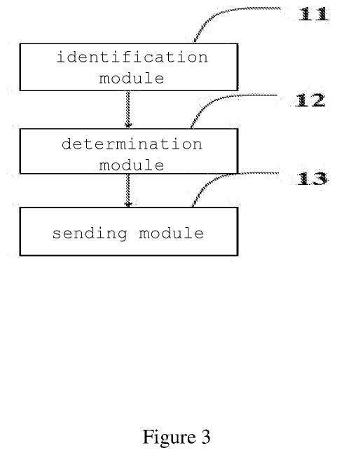

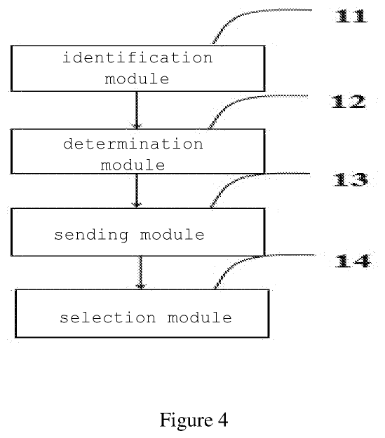

Referring to FIG. 3, in order to further explain the video stream based live stream interaction method of the present disclosure, a modular description thereof is provided. A video stream based live stream interaction device is provided. In an embodiment, the device includes an identification module 11, a determination module 12, and a sending module 13. In addition, in the embodiment shown in FIG. 4, the device further includes a selection module 14.

The identification module 11 is configured for performing image recognition on a received video stream of a streamer, and acquiring feature change information of a featured object in the video stream, thereby generating a corresponding action event.

In an embodiment of the present disclosure, to obtain the feature change information of the featured object in the video stream thereby generating a corresponding action event, the device further includes an identification unit for identifying a featured object in each image frame of each received video stream; a determination unit for determining feature change information from features included in each of the image frames when a plurality of consecutive image frames include preset features of the featured object; and a match unit for matching the determined feature change information with a preset action event parameter template, and when the feature change information matches one of the parameter templates, generating an action event corresponding to one of the parameter templates.

The featured object is a reference for extracting its dynamic change information to determine a state of a play event in the current video stream, and it may be any one of a person character, an item character, and a moving part in the video stream, for example, a streamer of a current live streaming room or the game character of a currently live video game event or players of currently live video game and the like.

When identifying the featured object in the video stream, the dynamic change process of the feature is specifically identified. When a plurality of consecutive image frames including preset reference features of the featured object are identified, change information of the feature between different image frames is further identified. The change information of the featured object is a change in position, shape, or both position and shape, of the person character, item character, or the moving part in a plurality of consecutive image frames of the video stream.

Specifically, when a plurality of consecutive image frames are played, in case that the position or shape of the specific feature of the featured object included therein has changed, then such change is determined as the feature change information among the features included in each of the image frame.

In a possible application scenario, for example, a current event streaming live is a game event, and when a killing action of a certain game character is recognized, the recognition process may specifically identify the shape of the sword or other devices held by the game character and changes in the position of the game character's arm or body to determine the completion of this killing action. When the action is finished, the completion of a killing action would be recorded as feature change information of the game character.

In the embodiment of the present disclosure, the corresponding action events generated by the determined feature change information are specifically implemented by matching the description parameter items of each other. The feature change information and the parameter template share the same parameter description items, and the same parameter description items are compared with each other to realize the match between each other.

For example, in the application scenario of the above-mentioned video game live broadcast, the parameter description item of the killing action may be: change in the arm coordinates of the killer, coordinate change of the center point of the body, and shape change of the sword. The feature change parameter description items of the corresponding featured object are: coordinate changes of features a and b of featured object A, and shape change of featured object B. In this embodiment, the featured object A is a killer, the feature a is its arm, the feature b is its body center point, and the featured object B is a sword. The parameter description items are: coordinate change of the arm of the killer, coordinate change of the center point of the body, and the shape change of the sword. When this dynamic change information of the featured object is identified, it is determined that it completes a kill action.

A determination module 12 is used for determining a preset response instruction for the action event according to the action event itself.

In the embodiment of the present disclosure, a mapping relationship between the action event and its response instruction is pre-stored by a terminal in order to determine a preset response instruction for the action event. When it is recognized that a certain action event occurs, a corresponding response instruction according to the mapping relationship is determined, so that the terminal executes the instruction to send feedback information to at least one user in the live stream room in response to the event.

The mapping relationship includes a corresponding relationship between an attribute of the action event and response instruction. In a possible design, the mapping relationship further includes a corresponding relationship between the number of times the action event is sent and response instruction. The corresponding relationship is used to represent that the response instruction is determined if and only if the action event reaches for a predetermined number of occurrence. In one possible design, the mapping relationship includes different response instructions correspond to different number of occurrences of particular action events.

For example, in the application scenario of the above video game live broadcast, when it is recognized that a game character M completes one kill, the preset response instruction is giving a thumb-up and the number of kill actions is counted. When it is recognized that it completes two killing actions, the preset response instruction is to send a gift, and continue to count the number of killing actions, so that when the terminal responds to the killing actions, feedback information including sending the gift, or thumb-up and the number of times the game character M completes the killing are displayed in a user interface.

In one embodiment, when receiving the configuration of the response instruction for the preset action event, the action event is stored in association with the corresponding response instruction to refresh the mapping relationship in real time to determine the response instruction according to the action event.

A sending module 13 is used for executing the response instruction to send feedback information to at least one user in a live streaming room, in response to the action event.

In one embodiment, the response instruction in the embodiment of the present disclosure is specifically in the following form: in the form of a dispatch instruction for dispatching an electronic gift to a streamer, the instruction causing at least a notification information including dispatching of the electronic gift to the streamer.

For example, in a live game, when the game character completes five consecutive killing actions, the terminal automatically recognizes the dynamic change information of the game character, and automatically sends an electronic gift such as displaying achievements or a virtual gift. Delivery notification information including dispatching of the electronic gift to at least one user in the live stream room when the terminal executes the instruction. In one embodiment, the number of kill actions of the game character is also displayed on the user interface. When the user misses the killing scene of the game character due to temporary departure or other things, he can still make corresponding interactions through the notification information and the killing result displayed on the user interface, thus enhancing the interaction between users and the live broadcast party, and improving the user experience.

The response instruction in an embodiment of the present disclosure is in a form of a sending instruction for sending a preset text to a streamer, the instruction causing generation of a notification information including at least the text to be sent to the streamer.

When the response instruction is executed, the preset text information may be information such as the number of occurrences of dynamic change information in the live video stream or the attributes and quantity of the virtual gifts that are sent out due to identification of certain dynamic change information. The text information is used to let the user know the dynamic change process and the feedback information that the terminal made in response to the dynamic change process. In this case, the user does not have to manually confirm the progress of the current live event, and the user can infer the event that has occurred from the notification information, so that the user can follow the progress of the live event in real time and user experience is improved.

The response instruction in an embodiment of the present disclosure is in a form of a broadcast instruction for broadcasting a preset text to a live stream room, the instruction causing a plurality of users in the live stream room to receive a notification information including the text.

When the response instruction is executed, the notification information fed back is used to be sent to all users in the live stream room, ensuring that all users can receive the notification information.

It should be noted that the type of the response instruction described in the embodiment of the present disclosure may also be other instructions, which are not limited to the above three types of instructions, and are not limited herein.

Referring to FIG. 4, in another embodiment of the present disclosure, a selection module 14 is further included for receiving a selection by the user of one or more featured objects on the featured object list provided by the live stream room. The selected featured object is determined as the featured object for subsequent image recognition, and the featured objects listed on the list are displayed as thumbnails corresponding to the featured objects in the video stream.

In the embodiment of the present disclosure, the video stream may include multiple featured objects. When multiple featured objects appear on the same screen at the same time, the user may select to pay special attention to the dynamic change information of a certain feature. For example, during the live broadcast of a game, the user only wants to pay attention to the performance of the contestants he cares about. At this time, the user can pay attention to one or more featured objects by selecting from the featured object lists.

Specifically, the terminal provides a user interaction interface for selecting featured objects, so that the user may selects one or more featured objects on the featured objects list, and the terminal determines that the selected featured objects as the featured object for subsequent image recognition. When the video stream is undergoing image-recognition, dynamic information change of the selected featured object is identified and recorded, so that the terminal executes a corresponding response instruction according to the recognition result, so as to feed back the corresponding notification information to the users in the live stream room.

The featured objects listed on the list are displayed as thumbnails corresponding to the featured object in the video stream. The featured object list further includes a reference feature preset for the featured object to determine an initial state of the same featured object in the video stream image to determine the feature change information.

For example, when the user selects one or more featured objects as the ones to be identified, the terminal determines an initial state of a featured object to be identified according to the featured object list, and the initial state is a reference point for dynamic information change. Based on this, its subsequent dynamic change information is determined.

In combination with the above embodiments, the greatest effect of the present disclosure lies in: in the present disclosure, by performing image recognition on the video stream of the received streamer, feature dynamic change information of featured object such as person character, item characters, or moving parts in the video stream is obtained. When it is recognized that the dynamic change information of a certain featured object of the pre-stored featured object list matches the parameter of the preset action event, a corresponding action event is generated. According to the action event, a preset response instruction corresponding to the action event is performed, to send feedback information corresponding to the action event to at least one user in the live stream room.

Through the implementation of the present disclosure, the terminal can automatically identify the change process or progress of the live event of the live stream room, and perform corresponding automatic interaction operations according to the changed process of the identified event, thereby avoiding the progress of each event being confirmation by the user, and enhancing flexibility and ease of operation of the solution. In addition, the user can interact with the streamer according to the automatic interactive notification information sent by the terminal, thereby enhancing the interaction between the user and the live broadcast party, improving user experience.

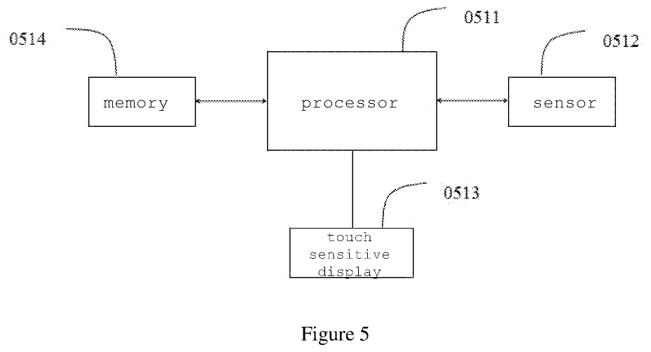

An embodiment of the disclosure further provides a mobile terminal, as shown in FIG. 5.

For the convenience of description, only the parts related to the embodiment of the present disclosure are shown. Please refer to the picture classification display method of the embodiment of the present disclosure to understand the specific technical details not disclosed. The terminal may be any terminal device including a mobile phone, a tablet computer, a PDA (Personal Digital Assistant), a POS (Point of Sales), a vehicle-mounted computer, and the terminal is a mobile phone as an example.

FIG. 5 is a block diagram showing a partial structure of a mobile phone related to a terminal provided by an embodiment of the present disclosure. Referring to FIG. 5, the mobile phone includes a touch-sensitive display 0513, a processor 0511, a memory 0514, and the like. It will be understood by those skilled in the art that the structure of the mobile phone shown in FIG. 5 does not constitute a limitation to the mobile phone, and may include more or less components than those illustrated, or combine some components or have different component configurations.

The following is a detailed introduction of each component of the mobile phone with reference to FIG. 5.

The memory 0514 can be used to store software program and modules, and the processor 0511 executes various functional applications and data processing by running software programs and modules stored in the memory 0514. The memory 0514 may mainly include a storage program area and a storage data area, wherein the storage program area may store an operating system, an application required for at least one function (such as a sound playing function, an image playing function, etc.), and the like; the storage data area may be stored according to The data created by the user of the mobile phone (such as audio data, phone book, etc.) and the like. Moreover, memory 0514 can include high speed random access memory, and can also include non-volatile memory, such as at least one magnetic disk storage device, flash memory device, or other volatile solid state storage device.

The touch sensitive display 0513 can include two parts: a touch detection device and a touch controller. Here, the touch detection device detects the touch orientation of the user, detects a signal brought by the touch operation, and transmits the signal to the touch controller. The touch controller receives touch information from the touch detection device and converts it into contact coordinates, sends it to the processor, and can receive and process commands from the processor. In addition, various types of touch-sensitive displays such as resistive, capacitive, infrared and surface acoustic wave touch-sensitive displays can be used.

The touch-sensitive display 0513 can be used to display information input by the user or information provided to the user and various menus of the mobile phone, such as an information editing interface. The touch-sensitive display 0513 may include a display panel. Alternatively, the touch-sensitive display may be configured in the form of a liquid crystal display (LCD), an organic light-emitting diode (OLED), or the like. Further, when the touch sensitive display 0513 detects a touch operation on or near it, it is transmitted to the processor to determine the type of the touch event, and then the processor provides corresponding visual output on the touch sensitive display according to the type of the touch event.

The mobile phone can also include at least one type of sensor 0512, such as a light sensor, motion sensor, and other sensors. Specifically, the light sensor may include an ambient light sensor and a proximity sensor, wherein the ambient light sensor may adjust the brightness of the display panel according to the brightness of the ambient light, and the proximity sensor may turn off the display panel and/or backlight when the mobile phone moves to the ear. As a kind of motion sensor, a gravity acceleration sensor can detect the magnitude of acceleration in all directions (usually three axes). When it is stationary, it can detect the magnitude and direction of gravity. It can be used to identify the gesture of the mobile phone (such as horizontal and vertical screen switching, related game, magnetometer attitude calibration), vibration recognition related functions (such as pedometer, tapping), etc.; and the mobile phone may also include other sensors such as gyroscope, barometer, hygrometer, thermometer, infrared sensor and the like.

The processor 0511 is a control center of the mobile phone that connects various portions of the entire cellphone with various interfaces and lines, by running or executing software programs and/or modules stored in the memory 0514, and recalling data stored in the memory 0514, The various functions and processing data of the mobile phone are performed to perform overall monitoring of the cellphone. Optionally, the processor 0511 may include one or more processing cores; in one embodiment, the processor 0511 may integrate an application processor and a modem processor, where the application processor mainly processes an operating system, a user interface, an application, and the like. The modem processor primarily handles wireless communications. It can be understood that the above modem processor may not be integrated into the processor 0511.

The mobile phone also includes a power supply(such as a battery) for powering various components. In one embodiment, the power supply can be logically coupled to the processor 0511 through a power management system to manage functions such as charging, discharging, and power management through the power management system.

Although not shown, the mobile phone may further include a camera, a Bluetooth module, and the like.

In the embodiment of the present disclosure, the processor 0511 included in the terminal further has the following functions:

performing image recognition on a received video stream of a streamer, and acquiring feature change information of a featured object in the video stream, thereby generating a corresponding action event;

determining a preset response instruction for the action event according to the action event itself; and

executing the response instruction to send feedback information to at least one user in a live streaming room in response to the action event.

The step of performing image recognition on a received video stream of a streamer and acquiring feature change information of a featured object in the video stream, thereby generating a corresponding action event includes the following steps:

identifying a featured object in each image frame of each received video stream;

determining feature change information from features included in each of the image frames when a plurality of consecutive image frames include preset features of the featured objects; and

matching the determined feature change information with a preset action event parameter template, and when the feature change information matches one of the parameter templates, generating an action event corresponding to one of the parameter templates.

The feature change information and the parameter template share the same parameter description items, and the same parameter description items with each other to realize match between each other.

The featured object is any one of a person character, an item character, and an moving part in the video stream, features of which are describable, and the corresponding feature change information is position and/or shape change information represented by the person character, the item character, or the moving part in a plurality of consecutive image frames of the video stream.

When performing image recognition on the images of the video stream, a reference feature preset for the featured object is used to determine an initial state of the featured object in the video stream image to determine the feature change information.

Selection of one or more of the featured objects by the user from a list provided by a live stream room is received, and the selected featured object is determined as a featured object for subsequent image recognition, the featured object listed on the list being displayed as a thumbnail in the video stream corresponding to the featured object.

A configuration of the response instruction of the preset action event is received, and the action event in association with the corresponding response instruction is stored to determine the response instruction of the preset action event according to the action event.

In the step of determining the response instruction of the preset action event according to the action event, the response instruction is determined if and only if the action event occurs for a predetermined number of times.

The response instruction is any of the following instructions:

a dispatch instruction for dispatching an electronic gift to a streamer, the instruction causing at least a notification information, which includes the information about dispatching the electronic gift to the streamer;

a sending instruction for sending a preset text to a streamer, the instruction causing generation of a notification information including at least the text to be sent to the streamer; and

a broadcast instruction for broadcasting a preset text to a live stream room, the instruction causing a plurality of users in the live stream room to receive a notification information including the text.

A person skilled in the art can clearly understand that for the convenience and brevity of the description, the specific working process of the system, device and unit described above can be known by referring to the corresponding process in the foregoing image classification display method embodiment, and details are not described herein again.

In the several embodiments provided by the present application, it should be understood that the disclosed system, apparatus, and picture classification display method may be implemented in other manners. For example, the device embodiments described above are merely illustrative. For example, the classification of the unit is only a classification in terms of logical function, and the actual implementation may have another classification manner, for example, multiple units or components may be combined or may be integrated into another system, or some features may be removed or not executed. In addition, the mutual coupling or direct coupling or communication connection shown or discussed may be an indirect coupling or communication connection through some interface, device or unit, and may be in an electrical, mechanical or other form.

The units described as separate components may or may not be physically separated, and the components displayed as units may or may not be physical units, that is, they may be located in one place, or may be distributed to multiple network units. Some or all of the units may be selected according to actual needs to achieve the purpose of the solution of the embodiment.

In addition, each functional unit in each embodiment of the present disclosure may be integrated into one processing unit, or each unit may exist physically and separately, or two or more units may be integrated into one unit. The above integrated unit can be implemented in the form of hardware or in the form of a software functional unit.

A person of ordinary skill in the art may understand that all or part of the steps of the various picture classification display methods of the foregoing embodiments may be completed by a program to command related hardware, and the program may be stored in a computer readable storage medium, and the storage medium may include: read only memory (ROM, Read Only Memory), random access memory (RAM, Random Access Memory), disk or CD, etc.

A person skilled in the art can understand that all or part of the steps of implementing the picture classification display method of the above embodiment can be completed by a program to instruct related hardware, and the program can be stored in a computer readable storage medium. The storage medium may be a read only memory, a magnetic disk or an optical disk or the like.

The foregoing embodiments describe a mobile terminal provided by the present disclosure in detail. For those skilled in the art, according to the idea of the embodiments of the present disclosure, there are changes in specific implementation manner and application scope. The content of this specification are not to be construed as limiting the disclosure.

1. A video stream based live stream interaction method, comprising the following steps:
performing image recognition on a received video stream of a streamer, and acquiring feature change information of a featured object in the video stream, thereby generating a corresponding action event;
determining a preset response instruction for the action event according to the action event itself; and
executing the response instruction to send feedback information to at least one user in a live streaming room in response to the action event.

2. The video stream based live stream interaction method according to claim 1, wherein the step of performing image recognition on a received video stream of a streamer and acquiring feature change information of a featured object in the video stream, thereby generating a corresponding action event comprises the following steps:
identifying a featured object in each image frame of each received video stream;
determining feature change information from features included in each of the image frames when a plurality of consecutive image frames include preset features of the featured object; and
matching the determined feature change information with a preset action event parameter template, and when the feature change information matches one of the parameter templates, generating an action event corresponding to one of the parameter templates.

3. The video stream based live stream interaction method according to claim 2, wherein the feature change information and the parameter template share same parameter description items, and the same parameter description items are compared with each other to realize match between each other.

4. The video stream based live stream interaction method according to claim 1, wherein the featured object is any one of a person character, an item character, and a moving part in the video stream, features of which are describable, and the corresponding feature change information is position and/or shape change information associated with the person character, the item character, or the moving part in a plurality of consecutive image frames of the video stream.

5. The video stream based live stream interaction method according to claim 1, wherein when performing image recognition on the images of the video stream, a reference feature preset for the featured object is used to determine an initial state of the featured object in the video stream image to determine the feature change information.

6. The video stream based live stream interaction method according to claim 1, further comprising the following step:
receiving selection of one or more of the featured objects by the user from a list provided by a live stream room, determining the selected featured object as a featured object for subsequent image recognition, the featured object listed on the list being displayed as a thumbnail in the video stream corresponding to the featured object.

7. The video stream based live stream interaction method according to claim 1, further comprising the following step:
receiving a configuration of the response instruction of the preset action event, and storing the action event associated with the corresponding response instruction to provide basis for determining the response instruction of the preset action event according to the action event.

8. The video stream based live stream interaction method according to claim 1, wherein in the step of determining the response instruction of the preset action event according to the action event, the response instruction is determined if and only if the action event occurs for a predetermined number of times.

9. The video stream based live stream interaction method according to claim 1, wherein the response instruction is any of the following instructions:
a dispatch instruction for dispatching an electronic gift to a streamer, the instruction causing at least a notification information including dispatching of the electronic gift to the streamer;
a sending instruction for sending a preset text to a streamer, the instruction causing generation of a notification information including at least the text to be sent to the streamer; and
a broadcast instruction for broadcasting a preset text to a live stream room, the instruction causing a plurality of users in the live stream room to receive a notification information including the text.

10. A video stream based live stream interaction device, comprising:
an identification module for performing image recognition on a received video stream of a streamer, and acquiring feature change information of a featured object in the video stream, thereby generating a corresponding action event;
a determination module for determining a preset response instruction for the action event according to the action event itself; and
a sending module for executing the response instruction to send feedback information to at least one user in a live streaming room in response to the action event.

11. A video stream based live stream interaction terminal, comprising:
A processor;
A non-volatile memory, which can be configured to store one or more applications, when executed by the processor, causes the terminal to perform at least the following steps:
performing image recognition on a received video stream of a streamer, and acquiring feature change information of a featured object in the video stream, thereby generating a corresponding action event;
determining a preset response instruction for the action event according to the action event itself; and
executing the response instruction to send feedback information to at least one user in a live streaming room in response to the action event.

12. The terminal as recited in claim 11, wherein when the terminal performs the step of performing image recognition on a received video stream of a streamer and acquiring feature change information of a featured object in the video stream, thereby generating a corresponding action event, the processor further causes the terminal to perform the following steps:
determining feature change information from features included in each of the image frames when a plurality of consecutive image frames include preset features of the featured object; and
matching the determined feature change information with a preset action event parameter template, and when the feature change information matches one of the parameter templates, generating an action event corresponding to one of the parameter templates.

13. The terminal as recited in claim 12, wherein the feature change information and the parameter template share same parameter description items, and the same parameter description items are compared with each other to realize match between each other.

14. The terminal as recited in claim 11, wherein the featured object is any one of a person character, an item character, and a moving part in the video stream, features of which are describable, and the corresponding feature change information is position and/or shape change information associated with the person character, the item character, or the moving part in a plurality of consecutive image frames of the video stream.

15. The terminal as recited in claim 11, wherein when the terminal is performing image recognition on the images of the video stream, a reference feature preset for the featured object is used to determine an initial state of the featured object in the video stream image to determine the feature change information.

16. The terminal as recited in claim 11, wherein the processor further causes the terminal to perform the following steps:
receiving selection of one or more of the featured objects by the user from a list provided by a live stream room, determining the selected featured object as a featured object for subsequent image recognition, the featured object listed on the list being displayed as a thumbnail in the video stream corresponding to the featured object.

17. The terminal as recited in claim 11, wherein the processor further causes the terminal to perform the following steps:
receiving a configuration of the response instruction of the preset action event, and storing the action event associated with the corresponding response instruction to provide basis for determining the response instruction of the preset action event according to the action event.

18. The terminal as recited in claim 11, wherein in the step of determining the response instruction of the preset action event according to the action event, the response instruction is determined if and only if the action event occurs for a predetermined number of times.

19. The terminal as recited in claim 11, wherein the response instruction is any of the following instructions:
a dispatch instruction for dispatching an electronic gift to a streamer, the instruction causing at least a notification information including dispatching of the electronic gift to the streamer;
a sending instruction for sending a preset text to a streamer, the instruction causing generation of a notification information including at least the text to be sent to the streamer; and
a broadcast instruction for broadcasting a preset text to a live stream room, the instruction causing a plurality of users in the live stream room to receive a notification information including the text.
